(19) United States
(12) Patent Application Publication
(10) Pub. No.: US 2023/0176516 A1
(43) Pub. Date: Jun. 8, 2023

(54) IMAGE FORMING DEVICE

(71) Applicant: KYOCERA Document Solutions Inc., Osaka (JP)

(72) Inventor: Satoru MIURA, Osaka-shi (JP)

(73) Assignee: KYOCERA Document Solutions Inc., Osaka (JP)

(21) Appl. No.: 17/906,155

(22) PCT Filed: Mar. 8, 2021
(86) PCT No.: PCT/JP2021/008991

§ 371 Date: Sep. 12, 2022

(30) Foreign Application Priority Data
Mar. 13, 2020 (JP) 2020-044235

(51) Int. Cl. G03G 15/00

(52) U.S. Cl. CPC G03G 15/70; G03G 15/5016

(57) ABSTRACT

An image forming device (100) includes a reading section (10), a conveyance section (20), an operation display section (110), storage (170), and a controller (160). The reading section (10) reads an image of a document to generate image data. The conveyance section (20) conveys the document to the reading section (10). The operation display section (110) displays an operation screen. The storage (170) stores therein first image data (171) of at least one page of the document read by the reading section (10) before a jam of the document occurs in the conveyance section (20). The controller (160) controls the operation display section (110) to display second image data (172) in association with the first image data (171). The second data (172) is image data of a page of the document read by the reading section (10) after resumption of conveyance of the document on the occasion of occurrence of the jam. The page corresponds to the at least one page that has been already read.

### TECHNICAL FIELD

The present invention relates to an image forming device.

### BACKGROUND ART

The image forming device disclosed in Patent Literature 1 includes an auto document feeder (ADF) and a controller, and prevents duplicate page printing even when a document for which printing has been done is re-set in resumption of printing operation after a jam occurs in the ADF. In order to do so, the controller always stores a characteristic of a read document, and performs control in a manner that printing is automatically resumed from a document with a characteristic that does not match the characteristic of the printed document without performing printing on a document with a characteristic that matches the characteristic of the printed document.

### CITATION LIST

### Patent Literature

### Patent Literature 1:

Japanese Patent Application Laid-Open Publication No. H09-236950

### SUMMARY OF INVENTION

### Technical Problem

A user cannot check a result of document reading duplicated between before and after occurrence a jam in the image forming device disclosed in Patent Literature 1.

The present invention has its object of providing an image forming device that can allow a user to easily check a result of document reading duplicated between before and after occurrence of a jam.

### Solution to Problem

An image forming device according to the present invention includes a reading section, a conveyance section, an image forming section, an operation display section, storage, and a controller. The reading section reads an image of a document to generate image data. The conveyance section conveys the document to the reading section. The image forming section forms an image on a recording medium based on the image data. The operation display section displays an operation screen. The storage stores first image data therein. The first image data contains at least one page of the document read by the reading section before a jam of the document occurs in the conveyance section. The controller controls the operation display section to display second image data in association with the first image data. The second image data is image data of a page of the document read by the reading section after resumption of conveyance of the document on an occasion of occurrence of the jam. The page corresponds to the at least one page of the document.

### Advantageous Effects of Invention

According to the present invention, an image forming device can be provided that can allow a user to easily check a result of document reading duplicated between before and after occurrence of a jam.

### BRIEF DESCRIPTION OF DRAWINGS

FIG. 1 is a schematic diagram illustrating an example of the configuration of an image forming device according to an embodiment.

FIG. 2 is a block diagram illustrating an example of the circuit configuration of the image forming device.

FIG. 3 is a flowchart depicting an example of processing by a controller.

FIG. 4 is a flowchart following FIG. 3.

FIG. 5 is a diagram illustrating an example of an operation screen.

FIG. 6 is a diagram illustrating an example of the operation screen.

### DESCRIPTION OF EMBODIMENTS

The following describes an embodiment of the present invention with reference to the accompanying drawings. Note that elements that are the same or equivalent are labeled the same reference signs in the drawings and description thereof is not repeated.

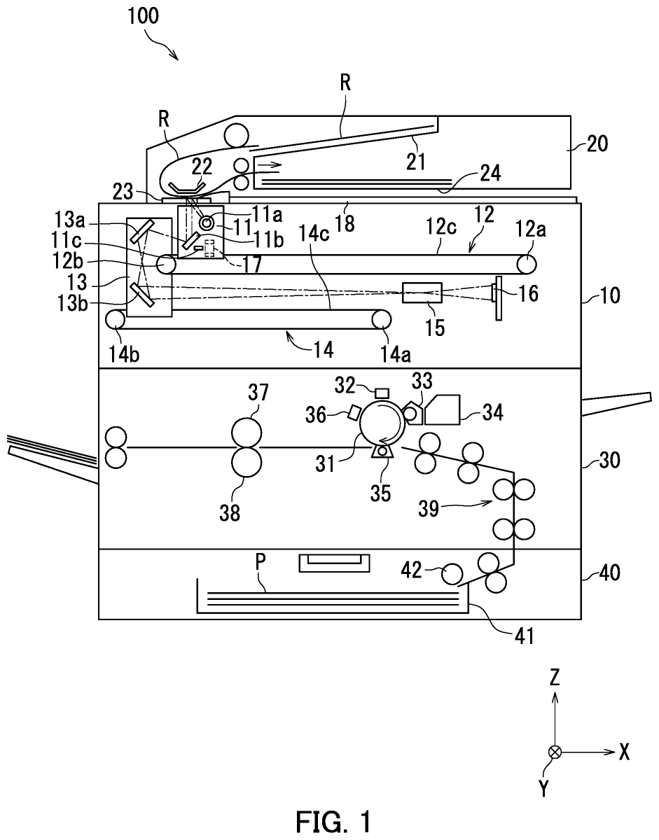

With reference to FIG. 1, an image forming device 100 according to an embodiment will be described. FIG. 1 is a schematic diagram illustrating an example of the configuration of the image forming device 100. In FIG. 1, a direction from the left to the right is defined as a positive X-axis direction, a direction from the front to the rear is defined as a positive Y-axis direction, and a direction from the bottom to the top is defined as a positive Z-axis direction for the sake of convenience.

As illustrated in FIG. 1, the image forming device 100 is a multifunction peripheral and has a copy function, a print function, and a scan function. The image forming device 100 includes an image reading section 10, an automatic document feeder (ADF) 20, an image forming section 30, and a sheet feed section 40.

The image reading section 10 reads an image of a document R to generate image data. The image reading section 10 corresponds to an example of a “reading section”.

The image reading section 10 includes a first carriage 11, a first transport mechanism 12, a second carriage 13, a second transport mechanism 14, an imaging lens 15, a charge coupled device (CCD) 16, a photointerrupter 17, and a document table 18.

A light source 11a, a first reflecting mirror 11b, and a light shield 11c are provided in the first carriage 11A.

The first transport mechanism 12 includes a pulley 12a, a pulley 12b, and a first belt 12c. The pulley 12a is mounted on the main body of the image reading section 10. The pulley 12b is spaced apart from the pulley 12a in a sub-scanning direction (direction along the X axis) and mounted on the second carriage 13. The first belt 12c is wound between the pulley 12a and the pulley 12b and connected to the first carriage 11. A stepper motor (not illustrated) rotationally drives the pulley 12a to move the first carriage 11 in the sub-scanning direction through the first belt 12c and move the second carriage 13 in the sub-scanning direction.

A second reflecting mirror 13a and a third reflecting mirror 13b are provided in the second carriage 13. The light source 11a irradiates the document R with white light. The first reflecting mirror 11b guides the reflected light from the document R to the second reflecting mirror 13a by changing the travel direction of the reflected light. The second reflecting mirror 13a guides the reflected light from the first reflecting mirror 11b to the third reflecting mirror 13b by changing the travel direction of the reflected light. The third reflecting mirror 13b guides the reflected light from the second reflecting mirror 13a to the imaging lens 15 by changing the travel direction of the reflected light.

The second transport mechanism 14 includes a pulley 14a, a pulley 14b, and a second belt 14c. The pulley 14a and the pulley 14b are spaced apart from each other in the sub-scanning direction and mounted on the main body of the image reading section 10. The second belt 14c is wound between the pulley 14a and the pulley 14b and connected to the second carriage 13.

The imaging lens 15 converges the reflected light from the third reflecting mirror 13b to form an image on the CCD 16. The CCD 16 converts the reflected light from the imaging lens 15 to an electric signal.

The photointerrupter 17 is fixed to the main body of the image reading section 10 and includes a light emitting section and a light receiving section. The light shield 11c is disposed so as to pass between the light emitting section and the light receiving section of the photointerrupter 17. The light shield 11c passes between the light emitting section and the light receiving section of the photointerrupter 17 as the first carriage 11 moves.

The document table 18 is formed from a transparent glass plate and provided on the upper surface of the image reading section 10.

The ADF 20 conveys the document R to the image reading section 10. The ADF 20 corresponds to an example of a “conveyance section”.

The ADF 20 includes a document feed tray 21, a document cover 22, ADF reading glass 23, and an exit tray 24. The document R loaded on the document feed tray 21 is automatically conveyed to pass between the document cover 22 and the ADF reading glass 23 and ejected onto the exit tray 24. The first carriage 11 is fixed below the ADF reading glass 23 and reads an image of the document R when the document R passes between the document cover 22 and the ADF reading glass 23.

The image forming section 30 electrographically forms an image on a sheet P based on image data of the document R read by the image reading section 10 or image data input from an external device. The sheet P corresponds to an example of a “recording medium”.

The image forming section 30 includes a photosensitive drum 31, a charger 32, a developing section 33, a toner container 34, a transfer section 35, a static eliminating section 36, a fixing roller 37, a pressure roller 38, and a conveyance roller group 39.

The charger 32 charges the outer circumferential surface of the photosensitive drum 31 to a specific potential. When a laser irradiator (not illustrated) irradiates the outer circumferential surface of the photosensitive drum 31 with laser light based on the image data, an electrostatic latent image corresponding to the image data is formed on the outer circumferential surface of the photosensitive drum 31.

The developing section 33 supplies toner to the outer circumferential surface of the photosensitive drum 31 and develops the electrostatic latent image into a toner image. The developing section 33 is replenished with the toner from the toner container 34. The transfer section 35 transfers the toner image on the photosensitive drum 31 to a sheet P. Thereafter, the static eliminating section 36 eliminates potential of the outer circumferential surface of the photosensitive drum 31.

The fixing roller 37 and the pressure roller 38 respectively apply pressure and heat to the sheet P with the toner image transferred thereto to melt the toner image, thereby fixing the toner image to the sheet P. The conveyance roller group 39 conveys the sheet P supplied from the sheet feed section 40 to the photosensitive drum 31.

The sheet feed section 40 includes a sheet feed cassette 41 and a sheet feed roller 42 for supplying a sheet P to the image forming section 30. The sheet feed cassette 41 is freely attachable to and detachable from the sheet feed section 40 and accommodates a plurality of sheets P in a stacked manner. The sheet feed roller 42 picks up the sheets P in the sheet feed cassette 41 one at a time to transport the sheet P to the conveyance roller group 39.

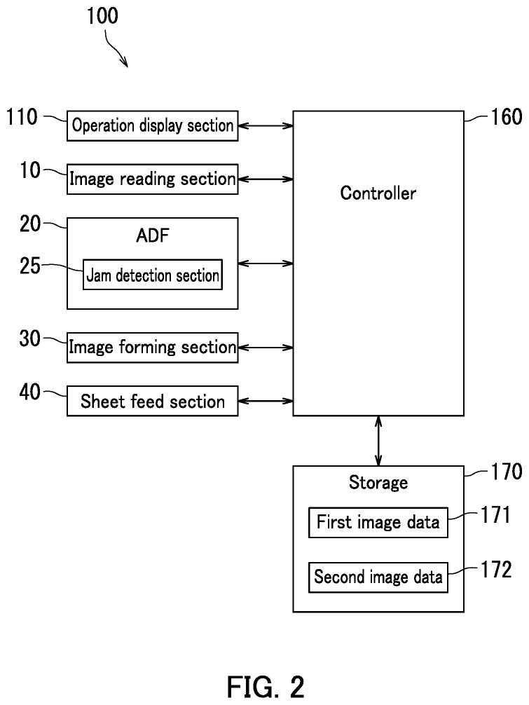

The circuit configuration of the image forming device 100 will be described next with reference to FIGS. 1 and 2. FIG. 2 is a block diagram of an example of the circuit configuration of the image forming device 100.

As illustrated in FIG. 2, the image forming device 100 includes an operation display section 110, a controller 160, and storage 170 in addition to the image reading section 10, the ADF 20, the image forming section 30, and the sheet feed section 40.

The ADF 20 includes a jam detection section 25. The jam detection section 25 detects a jam of the document R for example upon one page of the document R not passing a check point within a predetermined time.

The operation display section 110 displays an operation screen for receiving various user operations. The operation display section 110 includes a touch panel and an operation button.

The storage 170 includes a storage device. The storage device includes a main storage device (e.g., semiconductor memory) such as read-only memory (ROM) and random-access memory (RAM), and may further include an auxiliary storage device (e.g., a hard disk drive). Either or both the main storage device and the auxiliary storage device stores therein various data and various computer programs executed by the controller 160.

The controller 160 includes a processor such as a central processing unit (CPU). The processor of the controller 160 executes the computer programs stored in the storage device to control each element of the image forming device 100. Specifically, the processor of the controller 160 controls each operation of the image reading section 10, the ADF 20, the image forming section 30, the sheet feed section 40, the operation display section 110, and the storage 170.

The storage 170 stores first image data 171 and second image data 172 under control of the controller 160. The first image data 171 is image data of at least one page of the document R read by the image reading section 10 before a jam of the document R occurs in the ADF 20. The second image data 172 is image data of a page, of the document R read by the image reading section 10 after resumption of conveyance of the document R on the occasion of occurrence of the jam, which corresponds to the at least one page that has been already read. The controller 160 controls the operation display section 110 to display the first image data 171 and the second image data 172 in association with each other.

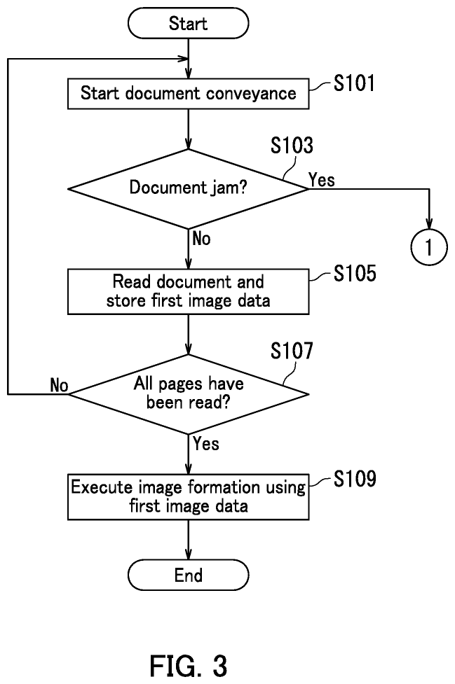

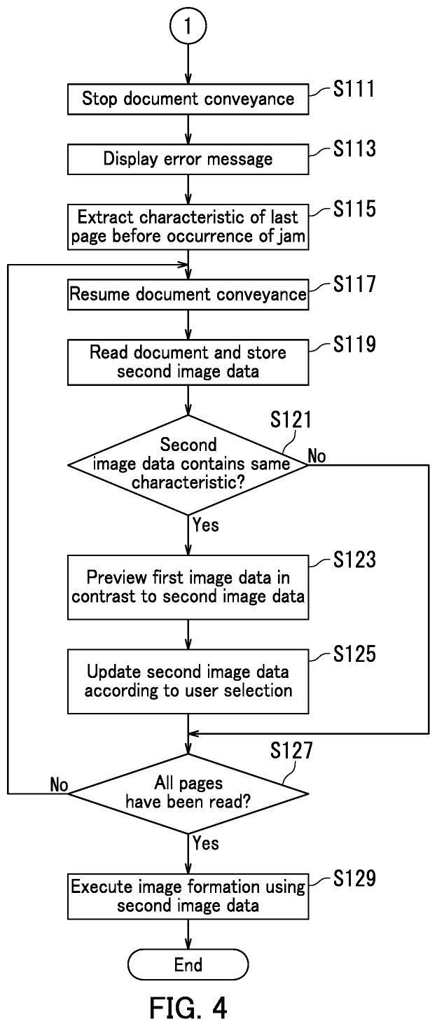

The processing by the controller 160 will be described next with reference to FIGS. 1 to 4. FIG. 3 is a flowchart depicting an example of the processing by the controller 160. FIG. 4 is a flowchart following FIG. 3.

Step S101: The controller 160 controls the ADF 20 to start conveyance of the document R as depicted in FIG. 3. Once the processing in Step S101 is completed, the processing by the controller 160 proceeds to Step S103.

Step S103: The controller 160 references the output from the jam detection section 25 to determine whether or not a jam of the document R has occurred. If the controller 160 determines that a jam of the document R has occurred (Yes in Step S103), the processing by the controller 160 proceeds to Step S111 depicted in FIG. 4. If the controller 160 determines that a jam of the document R has not occurred (No in Step S103), the processing by the controller 160 proceeds to Step S105.

Step S105: The controller 160 controls the image reading section 10 to execute reading of the document R and controls the storage 170 to store the first image data generated through the document R being read. Once the processing in Step S105 is completed, the processing by the controller 160 proceeds to Step S107.

Step S107: The controller 160 determines whether or not reading of all pages of the document R has been completed. If the controller 160 determines that reading of all the pages of the document R has not yet been completed (No in Step S107), the processing by the controller 160 returns to Step S101. If the controller 160 determines that reading of all the pages of the document R has been completed (Yes in Step S107), the processing by the controller 160 proceeds to Step S109.

Step S109: The controller 160 controls the image forming section 30 and the sheet feed section 40 so that image formation using the first image data 171 is executed. When the processing in Step S109 is completed, the processing by the controller 160 ends.

Step S111: The controller 160 controls the ADF 20 to stop conveyance of the document R for addressing the jam of the document R as depicted in FIG. 4. Once the processing in Step S111 is completed, the processing by the controller 160 proceeds to Step S113.

Step S113: The controller 160 controls the operation display section 110 to display an error message “jam occurs/please re-set document”. Once the processing in Step S113 is completed, the processing by the controller 160 proceeds to Step S115.

Step S115: The controller 160 extracts a characteristic of the last page among pages successfully read before occurrence of the jam. Examples of characteristic to be extracted include character arrangement in a text, shape of a figure in the text, and a page number in a header or a footer. Once the processing in Step S115 is completed, the processing by the controller 160 proceeds to Step S117.

Step S117: The controller 160 controls the ADF 20 to resume conveyance of the document R upon input of a user operation after re-set of the document R. Once the processing in Step S117 is completed, the processing by the controller 160 proceeds to Step S119.

Step S119: The controller 160 controls the image reading section 10 to execute reading of the document R and controls the storage 170 to store the second image data 172 generated through the document R being read. Once the processing in Step S119 is completed, the processing by the controller 160 proceeds to Step S121.

Step S121: The controller 160 determines whether or not the second image data 172 contains the same characteristic as that extracted at Step S115 from the last page contained in the first image data 171. If the second image data 172 contains the same characteristic as the extracted characteristic (Yes in Step S121), the processing by the controller 160 proceeds to Step S123. If the second image data 172 does not contain the same characteristic as the extracted characteristic (No in Step S121), the processing by the controller 160 proceeds to Step S127.

Step S123: The controller 160 controls the operation display section 110 to present to the user a preview contrasting the first image data 171 with the second image data 172. In order to do so, the controller 160 associates a page in the second image data 172 to a page in the first image data 171 based on the characteristic of the last page of the document R read by the image reading section 10 directly before occurrence of the jam. The operation display section 110 displays a message “document is duplicated” on a preview screen, and receives a user operation for selection as to which of the first image data 171 and the second image data 172 is to select. Once the processing in Step S123 is completed, the processing by the controller 160 proceeds to Step S125.

Step S125: The controller 160 controls the storage 170 to update the second image data 172 according to the selection by the user. That is, a page in the second image data 172 for which the user has determined that the first image data 171 before occurrence of the jam is more preferable than the second image data after resumption of conveyance of the document R is replaced with a corresponding page in the first image data 171.

Step S127: The controller 160 determines whether or not reading of all the pages of the document R has been completed. If the controller 160 determines that reading of all the pages of the document R has not yet been completed (No in Step S127), the processing by the controller 160 returns to Step S117. If the controller 160 determines that reading of all the pages of the document R has been completed (Yes in Step S127), the processing by the controller 160 proceeds to Step S129.

Step S129: The controller 160 controls the image forming section 30 and the sheet feed section 40 so that image formation using the second image data 172 is executed. When the processing in Step S129 is completed, the processing by the controller 160 ends.

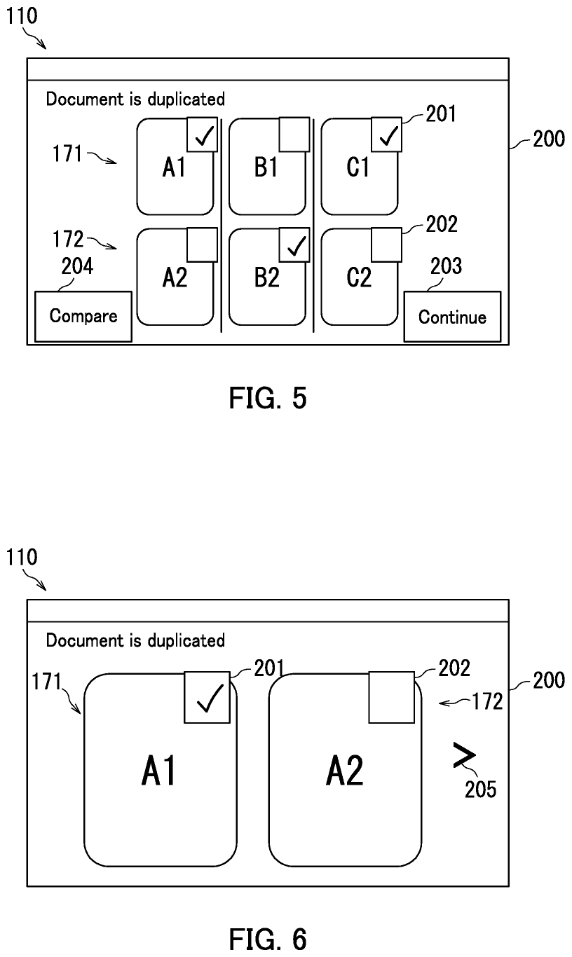

Lastly, the operation screen 200 displayed as the preview screen will be described with reference to FIGS. 1 to 6. FIGS. 5 and 6 each are a diagram illustrating an example of the operation screen 200.

As illustrated in FIG. 5, the operation screen 200 presents a preview of the first image data 171 before occurrence of the jam and a preview of the second image data 172 after resumption of conveyance of the document R in addition to the massage “document is duplicated”. The first image data 171 contains a first page A1, a second page B1, and a third page C1. The present example assumes that a jam of the document R occurs in a page directly after the third page C1. The second image data 172 contains a fourth page A2, a fifth page B2, and a sixth page C2.

The controller 160 extracts the characteristic of the third page C1 directly before occurrence of the jam, and then finds that the sixth page C2 has the same characteristic as the extracted characteristic. As a result, the sixth page C2 is associated with the third page C1. Based on the association, the fourth page A2 and the fifth page B2 are associated with the first page A1 and the second page B1, respectively. In the manner described above, the first page A1 is contrasted with the fourth page A2, the second page B1 is contrasted with the fifth page B2, and the third page C1 is contrasted with the sixth page C2 as illustrated in FIG. 5.

The first page A1, the second page B1, and the third page C1 are each provided with a first selection box 201. The fourth page A2, the fifth page B2, and the sixth page C2 are each provided with a second selection box 202. The user checks each reading quality of the first page A1 and the fourth page A2, determines which of the pages is to select, and places a check mark in one of the first selection box 201 and the second selection box 202. The user selects one of the second page B1 and the fifth page B2 and selects one of the third page C1 and the sixth page C2 in a likewise manner. In the example illustrated in FIG. 5, the first page A1 and the third page C1 each belonging to the first image data 171 and the fifth page B2 belonging to the second image data 172 are being selected. As a result, the fourth page A2 is replaced with the first page A1 and the sixth page C2 is replaced with the third page C1 in the storage 170.

The operation screen 200 further includes a continue button 203 and a compare button 204. When the user touches the continue button 203, conveyance of the document R is continued and image formation using the second image data 172 is executed. As a result, the first page A1, the fifth page B2, and the third page C1 are printed in the stated order.

When the user touches the compare button 204, respective pages in the first image data 171 and the second image data 172, which correspond to each other, for example, the first page A1 and the fourth page A2 are displayed in an enlarged scaled as illustrated in FIG. 6. This allows the user to easily contrast and observe both the pages. The operation screen 200 illustrated in FIG. 6 further includes an arrow 205. When the user touches the arrow 205, the next preview targets for contrast, for example, the second page B1 and the fifth page B2 are displayed in an enlarged scale.

According to the embodiment, an image forming device 100 can be provided that can allow a user to easily check a result of document reading duplicated between before and after occurrence of a jam. Moreover, according to the embodiment, inhibition of duplicate printing and increase in printing quality can be achieved.

An embodiment of the present invention has been described so far with reference to the accompanying drawings. However, the present invention is not limited to the above embodiment and can be implemented in various manners within a scope not deviating from the gist thereof. Furthermore, various inventions can be formed by appropriately combining any of the elements of configuration disclosed in the above embodiment. For example, some of all the elements of configuration indicated in the embodiment may be omitted. The drawings mainly illustrate various elements of configuration schematically for ease of understanding. Aspects such as each number of the elements of configuration illustrated in the drawings may differ in practice for convenience of drawing preparation. Furthermore, the elements of configuration indicated in the above embodiment each are one example and not a particular limitation. Various alterations can be made within a scope not substantially deviating from the effects of the present disclosure.

In the embodiment, the image forming device 100 is an electrographic image forming device. However, the present invention is not limited thereto. The image forming device 100 may be an inkjet image forming device, for example.

### INDUSTRIAL APPLICABILITY

The present invention can be used in the field of image forming device es.

1. An image forming device comprising:
a reading section configured to read an image of a document to generate image data;
a conveyance section configured to convey the document to the reading section;
an image forming section configured to form an image on a recording medium based on the image data;
an operation display section configured to display an operation screen;
storage that stores first image data therein, the first image data containing at least one page of the document read by the reading section before a jam of the document occurs in the conveyance section; and
a controller configured to control the operation display section to display second image data in association with the first image data, the second image data being image data of a page of the document read by the reading section after resumption of conveyance of the document on an occasion of occurrence of the jam, the page corresponding to the at least one page of the document.

2. The image forming device according to claim 1, wherein
the conveyance section includes a jam detection section that detects the jam, and
the controller references an output of the jam detection section to determine whether or not the jam has occurred.

3. The image forming device according to claim 2, wherein
upon determining that the jam had not occurred until reading of all pages of the document has been completed, the controller controls the image forming section to execute image formation using the first image data.

4. The image forming device according to claim 2, wherein
upon determining that the jam had occurred before reading of all pages of the document has been completed, the controller controls the conveyance section to stop conveyance of the document, and controls the operation display section to display a message prompting re-set of the document.

5. The image forming device according to claim 1, wherein
the controller extracts a characteristic of a last page of the document read by the reading section directly before occurrence of the jam and associates the second image data with the first image data based on the characteristic.

6. The image forming device according to claim 1, wherein
the operation display section receives a user operation for selection as to which of the first image data and the second image data is to select.

7. The image forming device according to claim 6, wherein
the controller updates the second image data according to the selection and controls the image forming section to execute image formation using the second image data.

8. The image forming device according to claim 1, wherein
the operation display section displays respective pages in the first image data and the second image data in an enlarged scale, the pages corresponding to each other.
